(19) United States
(12) Patent Application Publication
(10) Pub. No.: US 2026/0061598 A1
(43) Pub. Date: Mar. 5, 2026

(54) SIMULATION ROBOT ANKLE MECHANISM

(71) Applicant: Booster Robotics Technology Co., Ltd, Beijing (CN)

(72) Inventor: Kang LI, Beijing (CN)

(73) Assignee: Booster Robotics Technology Co., Ltd, Beijing (CN)

(21) Appl. No.: 19/285,496

(22) Filed: Jul. 30, 2025

(30) Foreign Application Priority Data
Sep. 3, 2024 (CN) 202422162484.1
Sep. 3, 2024 (CN) 2024112290850

(51) Int. Cl. B25J 9/00; B25J 17/00; B25J 19/00; B62D 57/032

(52) U.S. Cl. CPC B25J 9/0009; B25J 17/00; B25J 19/0025; B62D 57/032

(57) ABSTRACT

Disclosed is a simulation robot ankle mechanism, including an ankle assembly, where the ankle assembly includes an ankle cross shaft member and an ankle connecting rod; a transverse accommodating groove and a longitudinal accommodating groove are formed in the ankle cross shaft member, the transverse accommodating groove is provided with a transverse hinge portion, and the longitudinal accommodating groove is provided with a longitudinal hinge portion; the transverse hinge portion and the longitudinal hinge portion are distributed in a cross shape; a shank assembly is arranged above the ankle assembly, and the shank assembly includes a shank structural member; a foot plate adapter is arranged at a lower end of the ankle connecting rod; a first hinge clamping groove is formed at a lower end of the shank structural member, and a second hinge clamping groove is formed in the foot plate adapter.

### CROSS-REFERENCE TO RELATED APPLICATIONS

The application claims priority to Chinese patent application No. 2024112290850, and No. 202422162484.1 filed on Sep. 3, 2024, the entire contents of which are incorporated herein by reference.

### TECHNICAL FIELD

This disclosure belongs to technical field of robots, and in particular, to a simulation robot ankle mechanism.

### BACKGROUND

With the deepening of people's understanding of the intelligent essence of robot technology, robot technology has begun to continuously penetrate into various fields of human activities. Combined with the application characteristics of these fields, people have developed a variety of special robots and various intelligent robots with perception, decision-making, action and interaction capabilities.

A robot is a machine device that performs work automatically, which can receive human commands, run pre-programmed programs, or act in accordance with principles and guidelines formulated by artificial intelligence technology. The robot is a product of advanced integration cybernetics, mechanical electronics, computers, materials and bionics, and has important uses in various fields such as industry, medicine, agriculture, service industry, construction industry, and even military.

For simulation robots, a reliable mechanical structure design is a prerequisite for ensuring the realization of robot software control or programmed actions. Especially for humanoid bipedal robots, the weight distribution of the legs is an important factor affecting the performance of the robot, and the ankle part, as a supporting part of the leg, also plays a crucial role. The layout compactness, joint integration degree, and universality of the ankle structure are also critical. How to design a simulation robot ankle mechanism with a compact layout, a high joint integration degree, and high flexibility has important application value.

### SUMMARY

Therefore, this disclosure provides a simulation robot ankle mechanism, which has a more compact structure layout, a high degree of joint integration, and better flexibility.

To achieve the above objective, this disclosure provides a technical solution as follows: a simulation robot ankle mechanism, including an ankle assembly, where the ankle assembly includes an ankle cross shaft member and an ankle connecting rod;
a transverse accommodating groove and a longitudinal accommodating groove are formed in the ankle cross shaft member, the transverse accommodating groove is provided with a transverse hinge portion, and the longitudinal accommodating groove is provided with a longitudinal hinge portion; the transverse hinge portion and the longitudinal hinge portion are distributed in a cross shape; and
a shank assembly is arranged above the ankle assembly, and the shank assembly includes a shank structural member; a foot plate adapter is arranged at a lower end of the ankle connecting rod; a first hinge clamping groove is formed at a lower end of the shank structural member, and a second hinge clamping groove is formed in the foot plate adapter;
the transverse hinge portion is hinged to the first hinge clamping groove; the longitudinal hinge portion is hinged to the second hinge clamping groove;
the transverse hinge portion includes a first ankle transverse shaft needle roller bearing and a first ankle transverse shaft body; the first ankle transverse shaft needle roller bearing is located inside the transverse accommodating groove; and
the longitudinal hinge portion includes a second ankle transverse shaft needle roller bearing and a second ankle transverse shaft body; the second ankle transverse shaft needle roller bearing is located inside the longitudinal accommodating groove.

As a preferred solution of the simulation robot ankle mechanism, the transverse hinge portion further includes a left ankle transverse shaft gasket, a left ankle shaft end screw, a right ankle transverse shaft gasket, and a right ankle shaft end screw;
the first ankle transverse shaft body passes through a center of the first ankle transverse shaft needle roller bearing, a center of the left ankle transverse shaft gasket, and a center of the right ankle transverse shaft gasket; the left ankle transverse shaft gasket is filled on one side of the transverse accommodating groove, and the right ankle transverse shaft gasket is filled on the other side of the transverse accommodating groove;
one end of the first ankle transverse shaft body is exposed on an outer side of the left ankle transverse shaft gasket, and the other end of the first ankle transverse shaft body is exposed on an outer side of the right ankle transverse shaft gasket; the first hinge clamping groove is hinged to the first ankle transverse shaft body of the transverse hinge portion; and
the left ankle shaft end screw is connected to one end of the first ankle transverse shaft body, and the right ankle shaft end screw is connected to the other end of the first ankle transverse shaft body.

As a preferred solution of the simulation robot ankle mechanism, the longitudinal hinge portion further includes a front ankle transverse shaft gasket, a front ankle shaft end screw, a rear ankle transverse shaft gasket, and a rear ankle shaft end screw;
the second ankle transverse shaft body passes through a center of the second ankle transverse shaft needle roller bearing, a center of the front ankle transverse shaft gasket, and a center of the rear ankle transverse shaft gasket; the front ankle transverse shaft gasket is filled on one side of the longitudinal accommodating groove, and the rear ankle transverse shaft gasket is filled on the other side of the longitudinal accommodating groove;
one end of the second ankle transverse shaft body is exposed on an outer side of the front ankle transverse shaft gasket, and the other end of the second ankle transverse shaft body is exposed on an outer side of the rear ankle transverse shaft gasket; the second hinge clamping groove is hinged to the second ankle transverse shaft body of the longitudinal hinge portion; and
the front ankle shaft end screw is connected to one end of the second ankle transverse shaft body, and the rear ankle shaft end screw is connected to the other end of the second ankle transverse shaft body.

As a preferred solution of the simulation robot ankle mechanism, the shank assembly further includes a knee joint power output structural member, a knee joint passive end structural member, a first ankle joint drive motor, a second ankle joint drive motor, a first rocker arm swing member, and a second rocker arm swing member; the ankle assembly includes an ankle cross shaft member and an ankle connecting rod;
a knee joint drive motor is arranged between the knee joint power output structural member and the knee joint passive end structural member; a power output end of the knee joint drive motor is connected to the knee joint power output structural member, and the other end of the knee joint drive motor is connected to the knee joint passive end structural member;
an upper portion of the shank structural member is connected between a lower portion of the knee joint power output structural member and a lower portion of the knee joint passive end structural member, a lower portion of the shank structural member is connected to the ankle cross shaft member, and the ankle cross shaft member is fixed above the foot plate assembly;
a first motor mounting position and a second motor mounting position are formed on the shank structural member; the first ankle joint drive motor is fixed to the first motor mounting position, a power output end of the first ankle joint drive motor is connected to an upper portion of the first rocker arm swing member, and a lower portion of the first rocker arm swing member is connected to one side of the ankle connecting rod; and
the second ankle joint drive motor is fixed to the second motor mounting position, a power output end of the second ankle joint drive motor is connected to an upper portion of the second rocker arm swing member, and a lower portion of the second rocker arm swing member is connected to the other side of the ankle connecting rod.

As a preferred solution of the simulation robot ankle mechanism, an orientation of the power output end of the first ankle joint drive motor is opposite to an orientation of the power output end of the second ankle joint drive motor; and a length of the first rocker arm swing member is greater than that of the second rocker arm swing member.

As a preferred solution of the simulation robot ankle mechanism, the first rocker arm swing member includes an ankle long connecting rod, a first ankle rocker arm swing member, a first spherical bearing, a first connecting rod pin shaft, and a second spherical bearing;
a first mounting hole is formed in an upper portion of the ankle long connecting rod, a second mounting hole is formed in a lower portion of the ankle long connecting rod, and the first ankle rocker arm swing member is connected to the first mounting hole through the first spherical bearing and the first connecting rod pin shaft; the second spherical bearing is connected to the second mounting hole, and the ankle long connecting rod is hinged to one side of the ankle connecting rod through the second spherical bearing; and
a first drive interface is formed in the first ankle rocker arm swing member, and the first ankle rocker arm swing member is connected to the power output end of the first ankle joint drive motor through the first drive interface.

As a preferred solution of the simulation robot ankle mechanism, the second rocker arm swing member includes an ankle short connecting rod, a second ankle rocker arm swing member, a third spherical bearing, a second connecting rod pin shaft, and a fourth spherical bearing;
a third mounting hole is formed in an upper portion of the ankle short connecting rod, a fourth mounting hole is formed in a lower portion of the ankle short connecting rod, and the second ankle rocker arm swing member is connected to the third mounting hole through the third spherical bearing and the second connecting rod pin shaft; the fourth spherical bearing is connected to the fourth mounting hole, and the ankle short connecting rod is hinged to the other side of the ankle connecting rod through the fourth spherical bearing; and
a second drive interface is formed in the second ankle rocker arm swing member, and the second ankle rocker arm swing member is connected to the power output end of the second ankle joint drive motor through the second drive interface.

As a preferred solution of the simulation robot ankle mechanism, the simulation robot ankle mechanism further includes a foot plate assembly, where the foot plate adapter is fixed above the foot plate assembly.

The beneficial effects of this disclosure are as follows: an ankle assembly is included, where the ankle assembly includes an ankle cross shaft member and an ankle connecting rod; a transverse accommodating groove and a longitudinal accommodating groove are formed in the ankle cross shaft member, the transverse accommodating groove is provided with a transverse hinge portion, and the longitudinal accommodating groove is provided with a longitudinal hinge portion; the transverse hinge portion and the longitudinal hinge portion are distributed in a cross shape; a shank assembly is arranged above the ankle assembly, and the shank assembly includes a shank structural member; a foot plate adapter is arranged at a lower end of the ankle connecting rod; a first hinge clamping groove is formed at a lower end of the shank structural member, and a second hinge clamping groove is formed in the foot plate adapter; the transverse hinge portion is hinged to the first hinge clamping groove; and the longitudinal hinge portion is hinged to the second hinge clamping groove. According to this disclosure, the ankle structure is high in overall layout compactness and high in joint integration degree, so that a large movement range of a robot can be achieved, and flexibility and universality are improved.

### BRIEF DESCRIPTION OF THE DRAWINGS

To describe the technical solutions in the implementations or the prior art of this disclosure more clearly, a brief introduction will be given below to the drawings required in the description of the implementations or the prior art. Apparently, the drawings in the following description are merely exemplary, and those of ordinary skill in the art may further derive other implementation drawings according to the provided drawings without creative labor.

The structures, proportions, sizes and the like shown in the specification are only intended for matching the content disclosed herein and facilitating the understanding and reading of those skilled in the art rather than for limiting the implementation conditions of this disclosure. Therefore, they have no technically substantial significance, and any structural modifications, changes in proportions, or adjustments in size, without affecting the effects and objectives that this disclosure can produce and achieve, shall still fall within the scope of technical content disclosed in this disclosure.

FIG. 1 is a three-dimensional schematic diagram of a simulation robot adopting an ankle mechanism according to an embodiment of this disclosure;

FIG. 2 is a schematic diagram of a simulation robot ankle mechanism according to an embodiment of this disclosure;

FIG. 3 is a partially decomposition schematic diagram of a simulation robot ankle mechanism according to an embodiment of this disclosure;

FIG. 4 is a three-dimensional schematic diagram of a first view angle after a simulation robot ankle mechanism and a shank assembly are combined according to an embodiment of this disclosure;

FIG. 5 is a three-dimensional schematic diagram of a second view angle after a simulation robot ankle mechanism and a shank assembly are combined according to an embodiment of this disclosure; and

FIG. 6 is a decomposition schematic diagram of a simulation robot ankle mechanism and a peripheral structure according to an embodiment of this disclosure.

In the figures: 1. ankle assembly; 2. ankle cross shaft member; 3. ankle connecting rod; 4. transverse accommodating groove; 5. longitudinal accommodating groove; 6. transverse hinge portion; 7. longitudinal hinge portion; 8. shank assembly; 9. shank structural member; 10. foot plate adapter; 11. first hinge clamping groove; 12. second hinge clamping groove; 13. first ankle transverse shaft needle roller bearing; 14. first ankle transverse shaft body; 15. left ankle transverse shaft gasket; 16. left ankle shaft end screw; 17. right ankle transverse shaft gasket; 18. right ankle shaft end screw; 19. second ankle transverse shaft needle roller bearing; 20. second ankle transverse shaft body; 21. front ankle transverse shaft gasket; 22. front ankle shaft end screw; 23. rear ankle transverse shaft gasket; 24. rear ankle shaft end screw; 25. knee joint power output structural member; 26. knee joint passive end structural member; 27. first ankle joint drive motor; 28. second ankle joint drive motor; 29. first rocker arm swing member; 30. second rocker arm swing member; 31. first motor mounting position; 32. second motor mounting position; 33. ankle long connecting rod; 34. first ankle rocker arm swing member; 35. first spherical bearing; 36. first connecting rod pin shaft; 37. second spherical bearing; 38. first drive interface; 39. ankle short connecting rod; 40. second ankle rocker arm swing member; 41. third spherical bearing; 42. second connecting rod pin shaft; 43. fourth spherical bearing; 44. second drive interface; 45. foot plate assembly.

### DETAILED DESCRIPTION OF THE EMBODIMENTS

The following illustrates the implementations of this disclosure through specific embodiments, and those skilled in the art can easily understand other advantages and beneficial effects of this disclosure from the content disclosed in the specification. Apparently, the described embodiments are some but not all of the embodiments of this disclosure. Based on the embodiments in this disclosure, all other embodiments obtained by those of ordinary skill in the art without making creative labor fall within the scope of protection of this disclosure.

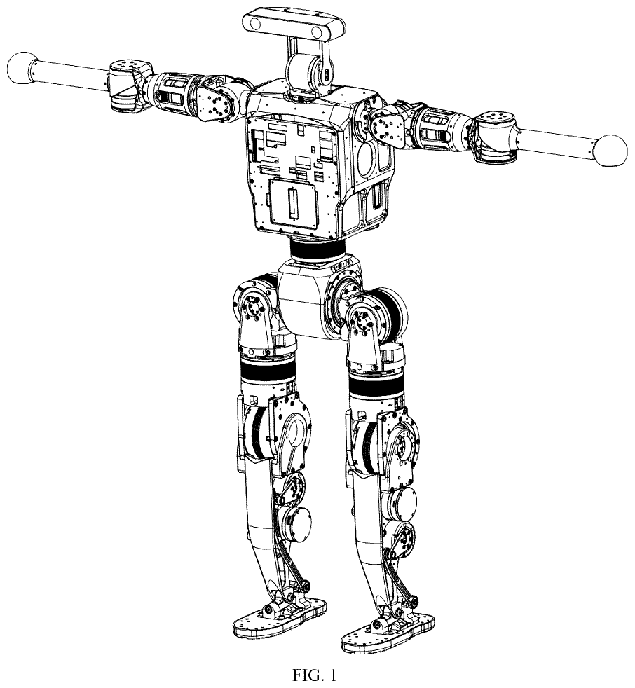

Referring to FIG. 1, the simulation robot adopting the ankle mechanism of the embodiment of this disclosure is provided with a head mechanism, a trunk mechanism, a left arm mechanism, a right arm mechanism, a hip mechanism, a left leg mechanism, and a right leg mechanism;
the head mechanism is connected to an upper end of the trunk mechanism, and the head mechanism has two degrees of freedom of motion: the head mechanism performs rotation and pitching motion relative to the trunk mechanism;
the left arm mechanism is connected to a left side of the trunk mechanism, and the left arm mechanism has four degrees of freedom of motion: the left arm mechanism performs rotation motion relative to the trunk mechanism, the left arm mechanism performs pitching motion relative to the trunk mechanism, an upper arm of the left arm mechanism rotates, and an elbow of the left arm mechanism swings forwards;
the right arm mechanism is connected to a right side of the trunk mechanism, and the right arm mechanism has four degrees of freedom of motion: the right arm mechanism performs rotation motion relative to the trunk mechanism, the right arm mechanism performs pitching motion relative to the trunk mechanism, an upper arm of the right arm mechanism rotates, and an elbow of the right arm mechanism swings forwards;
the hip mechanism is connected to a lower end of the trunk mechanism, and the hip mechanism has one degree of freedom of motion: the hip mechanism performs rotation motion relative to the trunk mechanism;
the left leg mechanism is connected to a left side of the hip mechanism, and the left leg mechanism has six degrees of freedom of motion: forward swing, side swing, rotation, knee forward swing, ankle forward swing, and ankle side swing motion of the left leg mechanism; and
the right leg mechanism is connected to a right side of the hip mechanism, and the right leg mechanism has six degrees of freedom of motion: forward swing, side swing, rotation, knee forward swing, ankle forward swing, and ankle side swing motion of the right leg mechanism.

A main controller and drive motors of the head mechanism, the trunk mechanism, the left arm mechanism, the right arm mechanism, the hip mechanism, the left leg mechanism, and the right leg mechanism are powered through a battery pack, and actions of the head mechanism, the trunk mechanism, the left arm mechanism, the right arm mechanism, the hip mechanism, the left leg mechanism, and the right leg mechanism are controlled through the main controller, so that the head mechanism performs rotation and pitching motion relative to the trunk mechanism, the left arm mechanism performs rotation motion relative to the trunk mechanism, the left arm mechanism performs pitching motion relative to the trunk mechanism, and the upper arm of the left arm mechanism rotates, and the elbow of the left arm mechanism swings forwards; the right arm mechanism performs rotation motion relative to the trunk mechanism, the right arm mechanism performs pitching motion relative to the trunk mechanism, and the upper arm of the right arm mechanism rotates, and the elbow of the right arm mechanism swings forwards; the hip mechanism performs rotation motion relative to the trunk mechanism; rotation of the hip mechanism relative to the left leg mechanism is achieved; rotation of the hip mechanism relative to the right leg mechanism is achieved; forward swing, side swing, rotation, knee forward swing, ankle forward swing, and ankle side swing motion of the left leg mechanism are achieved; and forward swing, side swing, rotation, knee forward swing, ankle forward swing, and ankle side swing motion of the right leg mechanism are achieved.

A binocular camera is mounted at a top end of the head mechanism. Rotation and pitching motion of the head binocular camera can be achieved through a head rotation drive motor and a head pitching drive motor. The head rotation drive motor for controlling the rotation of the binocular camera is fixed inside a trunk frame of the trunk mechanism, an output flange of the head rotation drive motor is connected to a fixed end of the head pitching drive motor for controlling the pitching of the binocular camera, and an output flange of the head pitching drive motor for controlling the pitching of the binocular camera is connected to a camera mounting assembly, thereby realizing the movement of the binocular camera.

A left arm rotation drive motor in the trunk frame can drive a left arm pitching drive motor, a left upper arm, a left elbow rotation drive motor, a left elbow swing drive motor, and a left forearm to rotate. The left arm pitching drive motor can drive the left upper arm, the left elbow rotation drive motor, the left elbow swing drive motor, and the left forearm to pitch. The left elbow rotation drive motor can drive the left elbow swing drive motor and the left forearm to rotate, and the left elbow swing drive motor can drive the left forearm to swing. A right arm rotation drive motor in the trunk frame can drive a right arm pitching drive motor, a right upper arm, a right elbow rotation drive motor, a right elbow swing drive motor, and a right forearm to rotate. The right arm pitching drive motor can drive the right upper arm, the right elbow rotation drive motor, the right elbow swing drive motor, and the right forearm to pitch. The right elbow rotation drive motor can drive the right elbow swing drive motor and the right forearm to rotate, and the right elbow swing drive motor can drive the right forearm to swing. A waist rotation drive motor can drive a hip structural member to rotate through a hip flange. A left leg swing drive motor in the hip structural member can drive the entire left leg mechanism to swing, and a right leg swing drive motor in the hip structural member can drive the entire right leg mechanism to swing.

For the left leg swing drive motor and the right leg swing drive motor, a clamping structural member can be connected to the hip structural member, and the clamping structural member fixes the left leg swing drive motor and the right leg swing drive motor in the hip structural member through a bolt. The hip mechanism drives a cross-leg drive assembly to swing through a leg swing drive motor, and a cross-leg drive motor of the cross-leg drive assembly can drive a thigh assembly and a shank assembly to stride outwards. The cross-leg drive motor is fixed by a cross-swing output structural member and a cross-swing passive end structural member, and performs power output through the cross-swing output structural member. The leg rotation drive motor can drive a leg rotation power output structural member between the cross-swing output structural member and the cross-swing passive end structural member to rotate, thereby driving a leg extension member, a knee joint drive motor, and a lower shank assembly to rotate as a whole.

The knee joint drive motor can drive the shank assembly to swing back and forth. The knee joint drive motor is fixed by a knee joint passive end structural member and a knee joint power output structural member, and the knee joint drive motor drives a shank structural member to swing back and forth through the knee joint power output structural member. A first ankle joint drive motor drives an ankle assembly to swing through a first rocker arm swing member, and a second ankle joint drive motor drives the ankle assembly to swing through a second rocker arm swing member. The lower portions of the first rocker arm swing member and the second rocker arm swing member swing relative to an ankle connecting rod, and the shank structural member swings relative to an ankle cross shaft member. When the first ankle joint drive motor drives the first rocker arm swing member and the second ankle joint drive motor drives the second rocker arm swing member in a same direction, the ankle cross shaft member performs forward swing motion relative to the shank structural member. When the first ankle joint drive motor drives the first rocker arm swing member and the second ankle joint drive motor drives the second rocker arm swing member in an opposite direction, the ankle cross shaft member performs side swing motion relative to the shank structural member. The ankle assembly can drive a foot plate assembly to perform corresponding forward swing and side swing motion.

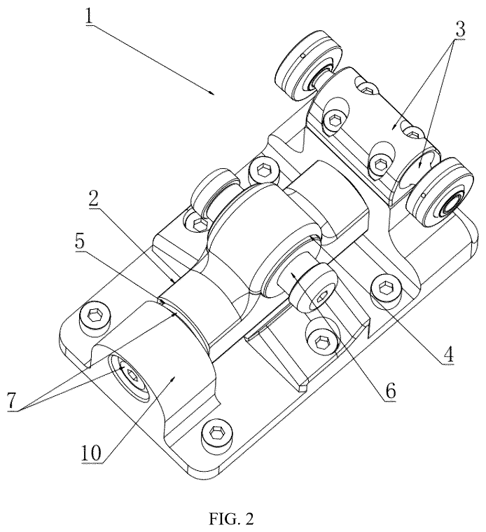

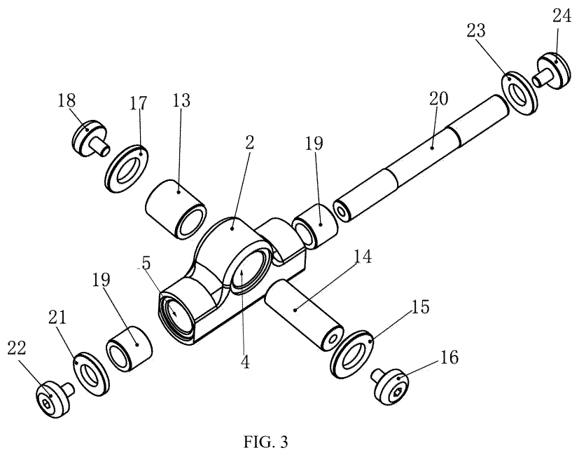

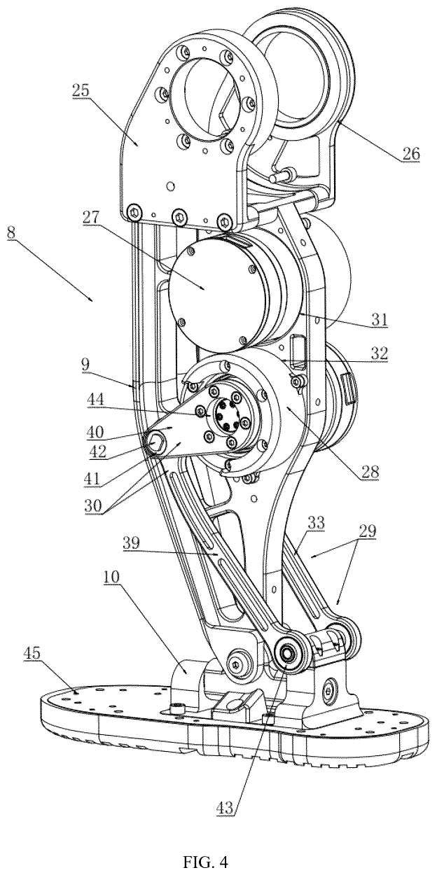

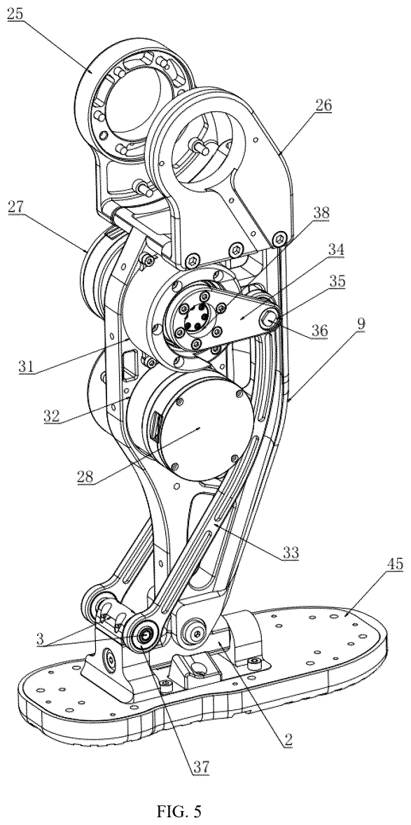

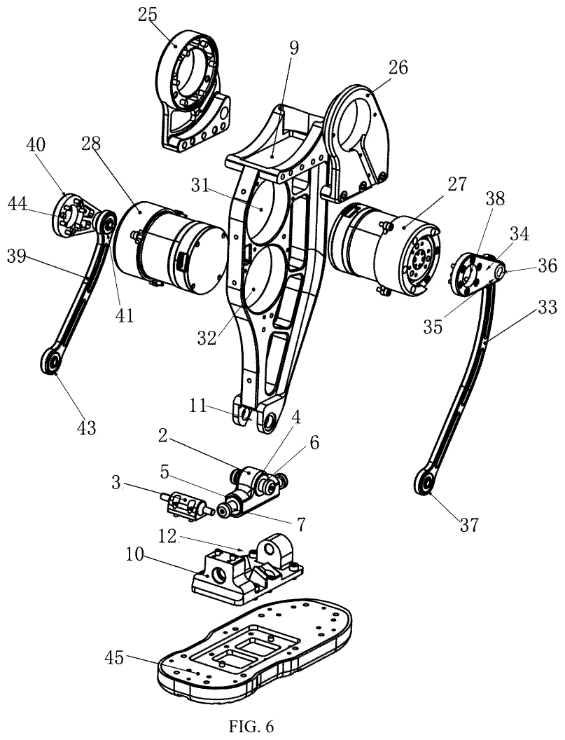

On the basis of the simulation robot developed by the applicant:
referring to FIG. 2, FIG. 3, FIG. 4, FIG. 5, and FIG. 6, this disclosure provides a simulation robot ankle mechanism, including an ankle assembly 1, where the ankle assembly 1 includes an ankle cross shaft member 2 and an ankle connecting rod 3;
a transverse accommodating groove 4 and a longitudinal accommodating groove 5 are formed in the ankle cross shaft member 2, the transverse accommodating groove 4 is provided with a transverse hinge portion 6, and the longitudinal accommodating groove 5 is provided with a longitudinal hinge portion 7; and the transverse hinge portion 6 and the longitudinal hinge portion 7 are distributed in a cross shape;
a shank assembly 8 is arranged above the ankle assembly 1, and the shank assembly 8 includes a shank structural member 9; a foot plate adapter 10 is arranged at a lower end of the ankle connecting rod 3; a first hinge clamping groove 11 is formed at a lower end of the shank structural member 9, and a second hinge clamping groove 12 is formed in the foot plate adapter 10; a foot plate assembly 45 is further included, and the foot plate adapter 10 is fixed above the foot plate assembly 45;
the transverse hinge portion 6 is hinged to the first hinge clamping groove 11; and the longitudinal hinge portion 7 is hinged to the second hinge clamping groove 12.

Specifically, the first hinge clamping groove 11 and the transverse hinge portion 6 serve to connect the shank structural member 9 and the ankle cross shaft member 2, and the shank structural member 9 rotates relative to the transverse hinge portion 6 of the ankle cross shaft member 2 through the first hinge clamping groove 11. The second hinge clamping groove 12 and the longitudinal hinge portion 7 serve to connect the foot plate adapter 10 and the ankle cross shaft member 2, and the foot plate adapter 10 rotates relative to the longitudinal hinge portion 7 of the ankle cross shaft member 2 through the second hinge clamping groove 12. The transverse hinge portion 6 and the longitudinal hinge portion 7 form a cross-shaped ankle cross shaft member 2 through the transverse accommodating groove 4 and the longitudinal accommodating groove 5, so that the structure is more compact, and the activity flexibility is higher.

Referring to FIG. 2 and FIG. 3, in this embodiment, the transverse hinge portion 6 includes a first ankle transverse shaft needle roller bearing 13, a first ankle transverse shaft body 14, a left ankle transverse shaft gasket 15, a left ankle shaft end screw 16, a right ankle transverse shaft gasket 17, and a right ankle shaft end screw 18; the first ankle transverse shaft needle roller bearing 13 is located inside the transverse accommodating groove 4, and the first ankle transverse shaft body 14 passes through a center of the first ankle transverse shaft needle roller bearing 13, a center of the left ankle transverse shaft gasket 15, and a center of the right ankle transverse shaft gasket 17; the left ankle transverse shaft gasket 15 is filled on one side of the transverse accommodating groove 4, and the right ankle transverse shaft gasket 17 is filled on the other side of the transverse accommodating groove 4; one end of the first ankle transverse shaft body 14 is exposed on an outer side of the left ankle transverse shaft gasket 15, and the other end of the first ankle transverse shaft body 14 is exposed on an outer side of the right ankle transverse shaft gasket 17; the first hinge clamping groove 11 is hinged to the first ankle transverse shaft body 14 of the transverse hinge portion 6; and the left ankle shaft end screw 16 is connected to one end of the first ankle transverse shaft body 14, and the right ankle shaft end screw 18 is connected to the other end of the first ankle transverse shaft body 14.

Specifically, the first ankle transverse shaft needle roller bearing 13 is sleeved inside the transverse accommodating groove 4, the first ankle transverse shaft body 14 is sleeved inside the first ankle transverse shaft needle roller bearing 13, and the left ankle transverse shaft gasket 15 and the right ankle transverse shaft gasket 17 are respectively sleeved on left and right sides of the transverse accommodating groove 4. After a lower portion of the shank structural member 9 is connected to the first ankle transverse shaft body 14 through the first hinge clamping groove 11, the shank structural member 9 is limited through the left ankle shaft end screw 16 and the right ankle shaft end screw 18, so that the first ankle transverse shaft body 14 can rotate relative to the transverse accommodating groove 4, and then the shank structural member 9 rotates relative to the transverse hinge portion 6 of the ankle cross shaft member 2 through the first hinge clamping groove 11.

The longitudinal hinge portion 7 includes a second ankle transverse shaft needle roller bearing 19, a second ankle transverse shaft body 20, a front ankle transverse shaft gasket 21, a front ankle shaft end screw 22, a rear ankle transverse shaft gasket 23, and a rear ankle shaft end screw 24; the second ankle transverse shaft needle roller bearing 19 is located inside the longitudinal accommodating groove 5, and the second ankle transverse shaft body 20 passes through a center of the second ankle transverse shaft needle roller bearing 19, a center of the front ankle transverse shaft gasket 21, and a center of the rear ankle transverse shaft gasket 23; the front ankle transverse shaft gasket 21 is filled on one side of the longitudinal accommodating groove 5, and the rear ankle transverse shaft gasket 23 is filled on the other side of the longitudinal accommodating groove 5; one end of the second ankle transverse shaft body 20 is exposed on an outer side of the front ankle transverse shaft gasket 21, and the other end of the second ankle transverse shaft body 20 is exposed on an outer side of the rear ankle transverse shaft gasket 23; the second hinge clamping groove 12 is hinged to the second ankle transverse shaft body 20 of the longitudinal hinge portion 7; and the front ankle shaft end screw 22 is connected to one end of the second ankle transverse shaft body 20, and the rear ankle shaft end screw 24 is connected to the other end of the second ankle transverse shaft body 20.

Specifically, the second ankle transverse shaft needle roller bearing 19 is sleeved inside the longitudinal accommodating groove 5, the second ankle transverse shaft body 20 is sleeved inside the second ankle transverse shaft needle roller bearing 19, and the front ankle transverse shaft gasket 21 and the rear ankle transverse shaft gasket 23 are respectively sleeved on front and rear sides of the longitudinal accommodating groove 5. After the foot plate adapter 10 is connected to the second ankle transverse shaft body 20 through the second hinge clamping groove 12, the foot plate adapter 10 is limited through the front ankle shaft end screw 22 and the rear ankle shaft end screw 24, so that the second ankle transverse shaft body 20 can rotate relative to the longitudinal accommodating groove 5, and then the foot plate adapter 10 rotates relative to the longitudinal hinge portion 7 of the ankle cross shaft member 2 through the second hinge clamping groove 12.

Referring to FIG. 4, FIG. 5 and FIG. 6, in this embodiment, the shank assembly 8 includes a knee joint power output structural member 25, a knee joint passive end structural member 26, a first ankle joint drive motor 27, a second ankle joint drive motor 28, a first rocker arm swing member 29, and a second rocker arm swing member 30; the ankle assembly 1 includes an ankle cross shaft member 2 and an ankle connecting rod 3; and
the knee joint drive motor is arranged between the knee joint power output structural member 25 and the knee joint passive end structural member 26; the power output end of the knee joint drive motor is connected to the knee joint power output structural member 25, and the other end of the knee joint drive motor is connected to the knee joint passive end structural member 26; the upper portion of the shank structural member 9 is connected between the lower portion of the knee joint power output structural member 25 and the lower portion of the knee joint passive end structural member 26, the lower portion of the shank structural member 9 is connected to the ankle cross shaft member 2, and the ankle cross shaft member 2 is fixed above the foot plate assembly 45; the first motor mounting position 31 and the second motor mounting position 32 are formed on the shank structural member 9; the first ankle joint drive motor 27 is fixed to the first motor mounting position 31, the power output end of the first ankle joint drive motor 27 is connected to the upper portion of the first rocker arm swing member 29, and the lower portion of the first rocker arm swing member 29 is connected to one side of the ankle connecting rod 3; and the second ankle joint drive motor 28 is fixed to the second motor mounting position 32, the power output end of the second ankle joint drive motor 28 is connected to the upper portion of the second rocker arm swing member 30, and the lower portion of the second rocker arm swing member 30 is connected to the other side of the ankle connecting rod 3.

Specifically, the knee joint drive motor is fixed by the knee joint passive end structural member 26 and the knee joint power output structural member 25, and the knee joint drive motor drives the shank structural member 9 to swing back and forth through the knee joint power output structural member 25. The first ankle joint drive motor 27 drives an ankle assembly 1 to swing through the first rocker arm swing member 29, and the second ankle joint drive motor 28 drives the ankle assembly to swing through the second rocker arm swing member 30. The lower portions of the first rocker arm swing member 29 and the second rocker arm swing member 30 swing relative to the ankle connecting rod 3, and the shank structural member 9 swings relative to the ankle cross shaft member 2. When the first ankle joint drive motor 27 drives the first rocker arm swing member 29 and the second ankle joint drive motor 28 drives the second rocker arm swing member 30 in the same direction, the ankle cross shaft member 2 performs forward swing motion relative to the shank structural member 9. When the first ankle joint drive motor 27 drives the first rocker arm swing member 29 and the second ankle joint drive motor 28 drives the second rocker arm swing member 30 in the opposite direction, the ankle cross shaft member 2 performs side swing motion relative to the shank structural member 9. The ankle assembly 1 can drive the foot plate assembly 45 to perform corresponding forward swing and side swing motion.

An orientation of the power output end of the first ankle joint drive motor 27 is opposite to an orientation of the power output end of the second ankle joint drive motor 28; and a length of the first rocker arm swing member 29 is greater than that of the second rocker arm swing member 30. Thus, when the first ankle joint drive motor 27 drives the first rocker arm swing member 29 and the second ankle joint drive motor 28 drives the second rocker arm swing member 30 in the same direction, the ankle cross shaft member 2 performs forward swing motion relative to the shank structural member 9. When the first ankle joint drive motor 27 drives the first rocker arm swing member 29 and the second ankle joint drive motor 28 drives the second rocker arm swing member 30 in the opposite direction, the ankle cross shaft member 2 performs side swing motion relative to the shank structural member 9. In addition, the first ankle joint drive motor 27, the second ankle joint drive motor 28, the first rocker arm swing member 29, and the second rocker arm swing member 30 are more compact in structure, and the activity flexibility is higher.

Referring to FIG. 4, FIG. 5, and FIG. 6 again, the first rocker arm swing member 29 includes an ankle long connecting rod 33, a first ankle rocker arm swing member 34, a first spherical bearing 35, a first connecting rod pin shaft 36, and a second spherical bearing 37; a first mounting hole is formed in an upper portion of the ankle long connecting rod 33, a second mounting hole is formed in a lower portion of the ankle long connecting rod 33, and the first ankle rocker arm swing member 34 is connected to the first mounting hole through the first spherical bearing 35 and the first connecting rod pin shaft 36; the second spherical bearing 37 is connected to the second mounting hole, and the ankle long connecting rod 33 is hinged to one side of the ankle connecting rod 3 through the second spherical bearing 37; and a first drive interface 38 is formed in the first ankle rocker arm swing member 34, and the first ankle rocker arm swing member 34 is connected to the power output end of the first ankle joint drive motor 27 through the first drive interface 38. The second rocker arm swing member 30 includes an ankle short connecting rod 39, a second ankle rocker arm swing member 40, a third spherical bearing 41, a second connecting rod pin shaft 42, and a fourth spherical bearing 43; a third mounting hole is formed in an upper portion of the ankle short connecting rod 39, a fourth mounting hole is formed in a lower portion of the ankle short connecting rod 39, and the second ankle rocker arm swing member 40 is connected to the third mounting hole through the third spherical bearing 41 and the second connecting rod pin shaft 42; the fourth spherical bearing 43 is connected to the fourth mounting hole, and the ankle short connecting rod 39 is hinged to the other side of the ankle connecting rod 3 through the fourth spherical bearing 43; and a second drive interface 44 is formed in the second ankle rocker arm swing member 40, and the second ankle rocker arm swing member 40 is connected to the power output end of the second ankle joint drive motor 28 through the second drive interface 44.

Specifically, the power output end of the first ankle joint drive motor 27 drives the first ankle rocker arm swing member 34 through the first drive interface 38, the first ankle rocker arm swing member 34 is hinged to the ankle long connecting rod 33 through the first spherical bearing 35 and the first connecting rod pin shaft 36, and then an upper end of the ankle long connecting rod 33 can be driven to swing through the first ankle rocker arm swing member 34. Meanwhile, a lower end of the ankle long connecting rod 33 is hinged to the ankle connecting rod 3 through the second spherical bearing 37, and the lower end of the ankle long connecting rod 33 can swing relative to the ankle connecting rod 3 in a swinging process. Meanwhile, the power output end of the second ankle joint drive motor 28 drives the second ankle rocker arm swing member 40 through the second drive interface 44, the second ankle rocker arm swing member 40 is hinged to the ankle short connecting rod 39 through the third spherical bearing 41 and the second connecting rod pin shaft 42, and then an upper end of the ankle short connecting rod 39 can be driven to swing through the second ankle rocker arm swing member 40.

Meanwhile, a lower end of the ankle short connecting rod 39 is hinged to the ankle connecting rod 3 through the fourth spherical bearing 43, and the lower end of the ankle short connecting rod 39 can swing relative to the ankle connecting rod 3 in a swinging process. The first ankle joint drive motor 27 and the second ankle joint drive motor 28 operate simultaneously during the movement of the shank mechanism, and operation directions of the first ankle joint drive motor 27 and the second ankle joint drive motor 28 can be controlled to be the same or opposite. That is, when the first ankle joint drive motor 27 drives the first rocker arm swing member 29 and the second ankle joint drive motor 28 drives the second rocker arm swing member 30 in the same direction, the ankle cross shaft member 2 performs forward swing motion relative to the shank structural member 9. When the first ankle joint drive motor 27 drives the first rocker arm swing member 29 and the second ankle joint drive motor 28 drives the second rocker arm swing member 30 in the opposite direction, the ankle cross shaft member 2 performs side swing motion relative to the shank structural member 9.

In conclusion, this disclosure includes an ankle assembly 1, where the ankle assembly 1 includes an ankle cross shaft member 2 and an ankle connecting rod 3; a transverse accommodating groove 4 and a longitudinal accommodating groove 5 are formed in the ankle cross shaft member 2, the transverse accommodating groove 4 is provided with a transverse hinge portion 6, and the longitudinal accommodating groove 5 is provided with a longitudinal hinge portion 7; the transverse hinge portion 6 and the longitudinal hinge portion 7 are distributed in a cross shape; a shank assembly 8 is arranged above the ankle assembly 1, and the shank assembly 8 includes a shank structural member 9; a foot plate adapter 10 is arranged at a lower end of the ankle connecting rod 3; a first hinge clamping groove 11 is formed at a lower end of the shank structural member 9, and a second hinge clamping groove 12 is formed in the foot plate adapter 10; the transverse hinge portion 6 is hinged to the first hinge clamping groove 11; and the longitudinal hinge portion 7 is hinged to the second hinge clamping groove 12. The first hinge clamping groove 11 and the transverse hinge portion 6 serve to connect the shank structural member 9 and the ankle cross shaft member 2, and the shank structural member 9 rotates relative to the transverse hinge portion 6 of the ankle cross shaft member 2 through the first hinge clamping groove 11. The second hinge clamping groove 12 and the longitudinal hinge portion 7 serve to connect the foot plate adapter 10 and the ankle cross shaft member 2, and the foot plate adapter 10 rotates relative to the longitudinal hinge portion 7 of the ankle cross shaft member 2 through the second hinge clamping groove 12. The transverse hinge portion 6 and the longitudinal hinge portion 7 form a cross-shaped ankle cross shaft member 2 through the transverse accommodating groove 4 and the longitudinal accommodating groove 5, so that the structure is more compact, and the activity flexibility is higher. The first ankle transverse shaft needle roller bearing 13 is sleeved inside the transverse accommodating groove 4, the first ankle transverse shaft body 14 is sleeved inside the first ankle transverse shaft needle roller bearing 13, and the left ankle transverse shaft gasket 15 and the right ankle transverse shaft gasket 17 are respectively sleeved on left and right sides of the transverse accommodating groove 4. After a lower portion of the shank structural member 9 is connected to the first ankle transverse shaft body 14 through the first hinge clamping groove 11, the shank structural member 9 is limited through the left ankle shaft end screw 16 and the right ankle shaft end screw 18, so that the first ankle transverse shaft body 14 can rotate relative to the transverse accommodating groove 4, and then the shank structural member 9 rotates relative to the transverse hinge portion 6 of the ankle cross shaft member 2 through the first hinge clamping groove 11. The second ankle transverse shaft needle roller bearing 19 is sleeved inside the longitudinal accommodating groove 5, the second ankle transverse shaft body 20 is sleeved inside the second ankle transverse shaft needle roller bearing 19, and the front ankle transverse shaft gasket 21 and the rear ankle transverse shaft gasket 23 are respectively sleeved on front and rear sides of the longitudinal accommodating groove 5. After the foot plate adapter 10 is connected to the second ankle transverse shaft body 20 through the second hinge clamping groove 12, the foot plate adapter 10 is limited through the front ankle shaft end screw 22 and the rear ankle shaft end screw 24, so that the second ankle transverse shaft body 20 can rotate relative to the longitudinal accommodating groove 5, and then the foot plate adapter 10 rotates relative to the longitudinal hinge portion 7 of the ankle cross shaft member 2 through the second hinge clamping groove 12. According to this disclosure, the ankle structure is high in overall layout compactness and high in joint integration degree, so that a large movement range of a robot can be achieved, and flexibility and universality are improved.

Although this disclosure has been described in detail with general descriptions and embodiments above, it is obvious to those skilled in the art that some modifications or improvements can be made based on this disclosure. Therefore, these modifications or improvements made without departing from the spirit of this disclosure all fall within the scope of protection claimed by this disclosure.

What is claimed is:

1. A simulation robot ankle mechanism, comprising an ankle assembly (1),
wherein the ankle assembly (1) comprises an ankle cross shaft member (2), and an ankle connecting rod (3);
a transverse accommodating groove (4) and a longitudinal accommodating groove (5) are formed in the ankle cross shaft member (2), the transverse accommodating groove (4) is provided with a transverse hinge portion (6), and the longitudinal accommodating groove (5) is provided with a longitudinal hinge portion (7); and the transverse hinge portion (6) and the longitudinal hinge portion (7) are distributed in a cross shape;
a shank assembly (8) is arranged above the ankle assembly (1), and the shank assembly (8) comprises a shank structural member (9); a foot plate adapter (10) is arranged at a lower end of the ankle connecting rod (3); a first hinge clamping groove (11) is formed at a lower end of the shank structural member (9), and a second hinge clamping groove (12) is formed in the foot plate adapter (10);
the transverse hinge portion (6) is hinged to the first hinge clamping groove (11); the longitudinal hinge portion (7) is hinged to the second hinge clamping groove (12);
the transverse hinge portion (6) comprises a first ankle transverse shaft needle roller bearing (13) and a first ankle transverse shaft body (14); the first ankle transverse shaft needle roller bearing (13) is located inside the transverse accommodating groove (4); and
the longitudinal hinge portion (7) comprises a second ankle transverse shaft needle roller bearing (19) and a second ankle transverse shaft body (20); the second ankle transverse shaft needle roller bearing (19) is located inside the longitudinal accommodating groove (5).

2. The simulation robot ankle mechanism according to claim 1, wherein the transverse hinge portion (6) further comprises a left ankle transverse shaft gasket (15), a left ankle shaft end screw (16), a right ankle transverse shaft gasket (17), and a right ankle shaft end screw (18);
the first ankle transverse shaft body (14) passes through a center of the first ankle transverse shaft needle roller bearing (13), a center of the left ankle transverse shaft gasket (15), and a center of the right ankle transverse shaft gasket (17); the left ankle transverse shaft gasket (15) is filled on one side of the transverse accommodating groove (4), and the right ankle transverse shaft gasket (17) is filled on the other side of the transverse accommodating groove (4);
one end of the first ankle transverse shaft body (14) is exposed on an outer side of the left ankle transverse shaft gasket (15), and the other end of the first ankle transverse shaft body (14) is exposed on an outer side of the right ankle transverse shaft gasket (17); the first hinge clamping groove (11) is hinged to the first ankle transverse shaft body (14) of the transverse hinge portion (6); and
the left ankle shaft end screw (16) is connected to one end of the first ankle transverse shaft body (14), and the right ankle shaft end screw (18) is connected to the other end of the first ankle transverse shaft body (14).

3. The simulation robot ankle mechanism according to claim 1, wherein the longitudinal hinge portion (7) further comprises a front ankle transverse shaft gasket (21), a front ankle shaft end screw (22), a rear ankle transverse shaft gasket (23), and a rear ankle shaft end screw (24);
the second ankle transverse shaft body (20) passes through a center of the second ankle transverse shaft needle roller bearing (19), a center of the front ankle transverse shaft gasket (21), and a center of the rear ankle transverse shaft gasket (23); the front ankle transverse shaft gasket (21) is filled on one side of the longitudinal accommodating groove (5), and the rear ankle transverse shaft gasket (23) is filled on the other side of the longitudinal accommodating groove (5);
one end of the second ankle transverse shaft body (20) is exposed on an outer side of the front ankle transverse shaft gasket (21), and the other end of the second ankle transverse shaft body (20) is exposed on an outer side of the rear ankle transverse shaft gasket (23); the second hinge clamping groove (12) is hinged to the second ankle transverse shaft body (20) of the longitudinal hinge portion (7); and
the front ankle shaft end screw (22) is connected to one end of the second ankle transverse shaft body (20), and the rear ankle shaft end screw (24) is connected to the other end of the second ankle transverse shaft body (20).

4. The simulation robot ankle mechanism according to claim 1, wherein the shank assembly (8) further comprises a knee joint power output structural member (25), a knee joint passive end structural member (26), a first ankle joint drive motor (27), a second ankle joint drive motor (28), a first rocker arm swing member (29), and a second rocker arm swing member (30);
a knee joint drive motor is arranged between the knee joint power output structural member (25) and the knee joint passive end structural member (26); a power output end of the knee joint drive motor is connected to the knee joint power output structural member (25), and the other end of the knee joint drive motor is connected to the knee joint passive end structural member (26);
an upper portion of the shank structural member (9) is connected between a lower portion of the knee joint power output structural member (25) and a lower portion of the knee joint passive end structural member (26), a lower portion of the shank structural member (9) is connected to the ankle cross shaft member (2), and the ankle cross shaft member (2) is fixed above the foot plate assembly (45);
a first motor mounting position (31) and a second motor mounting position (32) are formed on the shank structural member (9); the first ankle joint drive motor (27) is fixed to the first motor mounting position (31), a power output end of the first ankle joint drive motor (27) is connected to an upper portion of the first rocker arm swing member (29), and a lower portion of the first rocker arm swing member (29) is connected to one side of the ankle connecting rod (3); and
the second ankle joint drive motor (28) is fixed to the second motor mounting position (32), a power output end of the second ankle joint drive motor (28) is connected to an upper portion of the second rocker arm swing member (30), and a lower portion of the second rocker arm swing member (30) is connected to the other side of the ankle connecting rod (3).

5. The simulation robot ankle mechanism according to claim 4, wherein an orientation of the power output end of the first ankle joint drive motor (27) is opposite to an orientation of the power output end of the second ankle joint drive motor (28); and a length of the first rocker arm swing member (29) is greater than that of the second rocker arm swing member (30).

6. The simulation robot ankle mechanism according to claim 4, wherein the first rocker arm swing member (29) comprises an ankle long connecting rod (33), a first ankle rocker arm swing member (34), a first spherical bearing (35), a first connecting rod pin shaft (36), and a second spherical bearing (37);
a first mounting hole is formed in an upper portion of the ankle long connecting rod (33), a second mounting hole is formed in a lower portion of the ankle long connecting rod (33), and the first ankle rocker arm swing member (34) is connected to the first mounting hole through the first spherical bearing (35) and the first connecting rod pin shaft (36); the second spherical bearing (37) is connected to the second mounting hole, and the ankle long connecting rod (33) is hinged to one side of the ankle connecting rod (3) through the second spherical bearing (37); and
a first drive interface (38) is formed in the first ankle rocker arm swing member (34), and the first ankle rocker arm swing member (34) is connected to the power output end of the first ankle joint drive motor (27) through the first drive interface (38).

7. The simulation robot ankle mechanism according to claim 4, wherein the second rocker arm swing member (30) comprises an ankle short connecting rod (39), a second ankle rocker arm swing member (40), a third spherical bearing (41), a second connecting rod pin shaft (42), and a fourth spherical bearing (43);
a third mounting hole is formed in an upper portion of the ankle short connecting rod (39), a fourth mounting hole is formed in a lower portion of the ankle short connecting rod (39), and the second ankle rocker arm swing member (40) is connected to the third mounting hole through the third spherical bearing (41) and the second connecting rod pin shaft (42); the fourth spherical bearing (43) is connected to the fourth mounting hole, and the ankle short connecting rod (39) is hinged to the other side of the ankle connecting rod (3) through the fourth spherical bearing (43); and
a second drive interface (44) is formed in the second ankle rocker arm swing member (40), and the second ankle rocker arm swing member (40) is connected to the power output end of the second ankle joint drive motor (28) through the second drive interface (44).

8. The simulation robot ankle mechanism according to claim 4, further comprising a foot plate assembly (45), wherein the foot plate adapter (10) is fixed above the foot plate assembly (45).
